(19) United States
(12) Patent Application Publication
(10) Pub. No.: US 2025/0108695 A1
(43) Pub. Date: Apr. 3, 2025

(54) SYSTEM AND METHOD FOR MOTOR REGENERATION

(71) Applicant: Rivian IP Holdings, LLC, Irvine, CA (US)

(72) Inventors: Armin TEYMOURI, San Pedro, CA (US); Younes SANGSEFIDI, Irvine, CA (US); Chia-Chou YEH, Torrance, CA (US); Michael Andrew MILLER, San Clemente, CA (US)

(21) Appl. No.: 18/896,364

(22) Filed: Sep. 25, 2024

Related U.S. Application Data
(60) Provisional application No. 63/587,044, filed on Sep. 29, 2023.

(51) Int. Cl. B60L 7/14; B60L 50/51; B60L 50/61

(52) U.S. Cl. CPC B60L 7/14; B60L 50/51; B60L 50/61; B60L 2210/30; B60L 2210/44; B60L 2240/423; B60L 2240/549

(57) ABSTRACT

Systems and methods for motor regeneration are provided. One method for motor regeneration includes receiving a torque command and a maximum DC current from an electronic control unit, determining a drive unit loss, generating a DC current, and providing the DC current to a DC battery pack. Generating the DC current is based, at least in part, on the torque command, the maximum DC current, and the drive unit loss. The method advantageously generates the maximum amount of DC current that is acceptable by the battery pack while keeping the torque availability high and consistent. The generated DC current is also known as the maximum battery charge DC current.

### CROSS-REFERENCE TO RELATED APPLICATIONS

This application claims the benefit of U.S. Provisional Application Ser. No. 63/587,044 (filed on Sep. 29, 2023), the content of which is incorporated herein by reference in its entirety.

### INTRODUCTION

The present disclosure relates to electric vehicles (EVs). More particularly, the present disclosure relates to motor regeneration.

### SUMMARY

Embodiments of the present disclosure advantageously provide systems and methods for motor regeneration.

In certain embodiments, a method for motor regeneration is provided. The method includes receiving a torque command and a maximum DC current from an electronic control unit (ECU), determining a drive unit loss, generating a DC current, and providing the DC current to a DC battery pack. Generating the DC current is based, at least in part, on the torque command, the maximum DC current, and the drive unit loss.

The generated DC current is also known as the maximum battery charge DC current.

### BRIEF DESCRIPTION OF THE DRAWINGS

FIG. 1 depicts a diagram of an example electric vehicle, in accordance with embodiments of the present disclosure.

FIG. 2 presents a block diagram of example components of an EV, in accordance with embodiments of the present disclosure.

FIG. 3 presents a block diagram depicting data interfaces between several vehicle components, in accordance with embodiments of the present disclosure.

FIGS. 4A to 4E present example block diagrams for motor regeneration, in accordance with embodiments of the present disclosure.

FIG. 5 depicts a flow chart representing functionality associated with motor regeneration, in accordance with embodiments of the present disclosure.

### DETAILED DESCRIPTION

Generally, EVs may be classified into different categories based on the architecture of the propulsion system. All-electric vehicles (AEVs), also known as full-electric vehicles (FEVs) or battery electric vehicles (BEVs), are propelled by alternating current (AC) motors that are connected to gearboxes that drive the wheels. The AC motors are powered by a DC battery pack that must be periodically recharged at a charging station. Hybrid electric vehicles (HEVs) and plug-in hybrid electric vehicles (PHEVs) are also propelled by AC motors that are powered by a direct current (DC) battery pack, but additionally incorporate an internal combustion engine that drives a generator to recharge the DC battery pack. Some HEVs and PHEVs may also connect the internal combustion engine to a common gearbox or transmission to drive the wheels.

An electric drive unit (EDU) combines an AC motor, a gearbox, and a motor control unit (MCU) into a single mechanical package. The MCU includes, inter alia, a processor, a controller, etc., and an inverter that converts DC power provided by the battery pack to AC power provided to the AC motor. The inverter controls the speed and torque of the AC motor by adjusting the AC motor voltage frequency (proportional to speed) and the AC motor current (proportional to torque). Many EVs use Permanent-Magnet Synchronous Motors (PMSMs), which are powered by continuous sinusoidal AC current and use permanent magnets in the rotor (whose N-S axes may be axially aligned with the output shaft), and electromagnets in the stator. Other EVs use asynchronous AC induction motors, which use electromagnets in both the rotor and the stator. Synchronous reluctance motors (SynRM) and internal permanent-magnet IPM SynRMs may also be used.

A single-motor EV provides either front-wheel drive or rear-wheel drive, and has a front EDU connected to the front wheels or a rear EDU connected to the rear wheels, respectively. The EDU has a single AC motor, a single gearbox connected to a limited-slip differential, and a single MCU. The differential is connected to each front wheel or each rear wheel.

A dual motor EV provides all-wheel drive, and has a front EDU connected to the front wheels and a rear EDU connected to the rear wheels. Each EDU has a single AC motor, a single gearbox connected to a limited-slip differential, and a single MCU. The front EDU differential is connected to each front wheel, and the rear EDU differential is connected to each rear wheel.

A quad-motor EV also provides all-wheel drive, and has a front EDU connected to the front wheels, and a rear EDU connected to the rear wheels. Each EDU has two AC motors, two gearboxes, and two MCUs or a single MCU with two inverters. Each gearbox is connected to one wheel.

Generally, pressing down on the accelerator pedal causes each inverter to increase the frequency of the AC motor voltage provided to the respective AC motor, while releasing the pressure on the accelerator pedal causes each inverter to decrease the frequency of the AC motor voltage. Completely releasing the accelerator pedal causes each inverter to stop sending AC power to the respective AC motor, and depressing the brake pedal begins the braking process.

Traditional or friction braking applies the friction brakes (such as hydraulic disc brakes) of each wheel to slow down (and stop) the EV. A disc brake generates a torque in a direction that is opposite to the rotation of the wheel to reduce the speed of the wheel (and the EV).

Regenerative braking switches each AC motor into an AC generator that converts some of the kinetic energy of the EV into AC power while simultaneously providing at least a portion of the braking force required to slow down the EV. To support regenerative braking, each MCU includes a converter that converts the AC power generated by the AC motor/generator into DC power to recharge the DC battery pack. More particularly, the rotation of the wheel causes the rotation of the rotor within the stator to generate both AC power and a torque in a direction that is opposite to the rotation of the wheel. Because the AC power generated by the AC motor/generator is proportional to the torque generated by the AC motor/generator, controlling the torque also controls the AC power and the resultant DC power generated by the converter.

In many EVs, friction braking is combined with regenerative braking to generate a blended braking force to slow down (and stop) the EV. The blended braking force may be viewed as a blended torque that is a combination of the torque generated by friction braking and the torque generated by regenerative braking.

Under certain adverse battery conditions, the DC battery pack cannot accept the amount of DC current that the AC motor/generator and converter generate at a particular torque value, so the torque generated by the AC motor/generator must be significantly reduced to prevent damage to the DC battery pack. For example, a high battery pack state-of-charge (SoC) or a cold battery pack temperature will significantly reduce the maximum amount of DC current that is acceptable to the DC battery pack. Under these conditions, the EV control system will significantly reduce the torque generated by the AC motor/generator, which significantly reduces the DC current output by the converter, to prevent damage to the DC battery pack. Due to the blended nature of the braking force, a significant reduction of the regenerative braking torque during these conditions produces an unexpected and inconsistent deceleration, and a significant reduction in battery recharge capability.

Embodiments of the present disclosure advantageously provide a system and method for motor regeneration that does not significantly reduce the regenerative braking torque that may be generated during certain adverse battery conditions, such as a high battery pack SoC, a cold battery pack temperature, etc., while generating the maximum DC current that is acceptable to the DC battery pack. Advantageously, the motor regeneration system and method do not affect EV range or system efficiency.

In certain embodiments, a method for motor regeneration includes receiving, from a vehicle control unit, a torque command and a maximum DC current, determining a drive unit loss, generating a DC current, and providing the DC current to a DC battery pack. Generating the DC current is based, at least in part, on the torque command, the maximum DC current, and the drive unit loss. In certain embodiments, the DC current may be tuned based on the maximum DC current that may be accepted by the battery pack during charging (using, for example, an outer control loop), the commanded regeneration torque may be provided by increasing the drive unit loss, and the drive unit loss may be tuned to be as much as required by controlling the AC current value (using, for example, an inner control loop).

Embodiments of the present disclosure also provide many other advantageous features, such as consistent vehicle deceleration when battery charge acceptance limited, maximum possible charge current to the battery while increasing the regenerative brake capacity in high SoC and cold temperatures, real-time control over losses generated by each drive unit while controlling the value of the commanded regenerative torque, closed loop control of the battery charge current to its maximum possible value during regenerative braking, smooth transitions into and out of regenerative braking mode, improved battery lifetime by controlling the charge current below its capacity, system operation at the highest efficiency by giving priority to battery recharge over drive unit loss generation, automatic activation of regenerative braking, minimum latency with upstream vehicle ECUs, and more accurate and faster DC current control.

Embodiments of the present disclosure are generally applicable to any regenerative braking condition in which one or more AC motors are decelerating, such as during blended braking (friction and regenerative braking), one-pedal driving (regenerative braking only), operation of an electro-mechanical axle disconnect to slow or spin down the AC motor (regenerative braking only), etc.

Embodiments of the present disclosure provide additional advantageous features, including expanding the operation of the electro-mechanical axle disconnect by providing consistent motor regeneration capability, increasing the integrated loss generation for intentional generation of heat while still maximizing energy capture, assisting the deceleration of the electric vehicle during low speed Drive-to-Reverse and Reverse-to-Drive transitions when the friction brakes do not provide an effective solution (i.e., rolling shifts), providing a faster and more seamless vehicle braking response for short or medium duration to compensate for the slower-responding friction brakes, and providing a faster response time (for the removal of the braking effect) than friction brakes when the accelerator pedal is pressed.

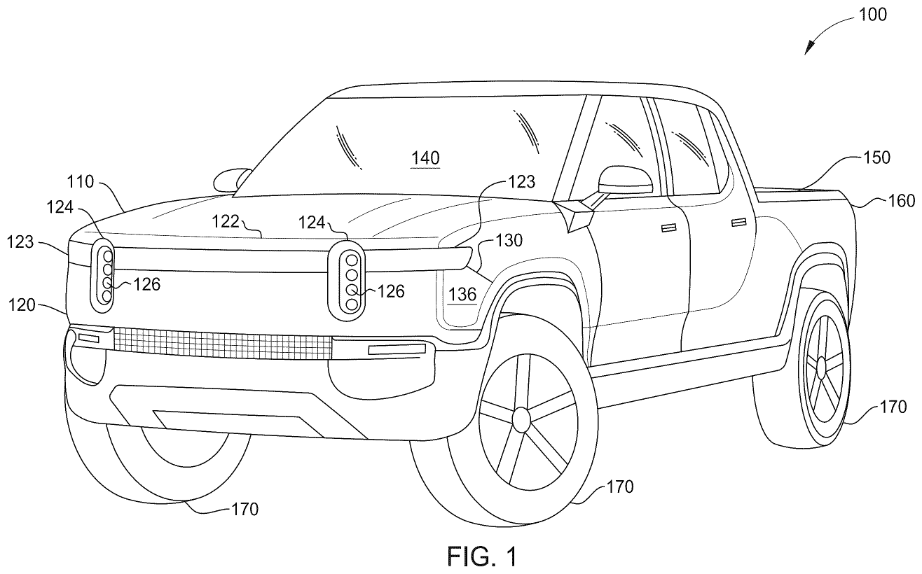

FIG. 1 depicts a diagram of electric vehicle 100, in accordance with embodiments of the present disclosure.

Electric vehicle 100 includes, inter alia, a frame and body 110, an electrical power storage and distribution system, a propulsion system, a suspension system, a steering system, auxiliary and accessory systems (such as thermal management, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, front turn lights 123, stadium light ring 124, headlights 126, charging port 130 with charging port cover 136 concealing charging connector socket, driver/passenger compartment or cabin 140, bed 150, rear end 160 with rear tail lights, a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more ECUs, one or more EDUs, wheels 170, etc. The electrical power storage and distribution system may include, inter alia, one or more ECUs, a battery pack including one or more battery modules, a vehicle charging subsystem including charging port 130, high voltage (HV) cables, etc.

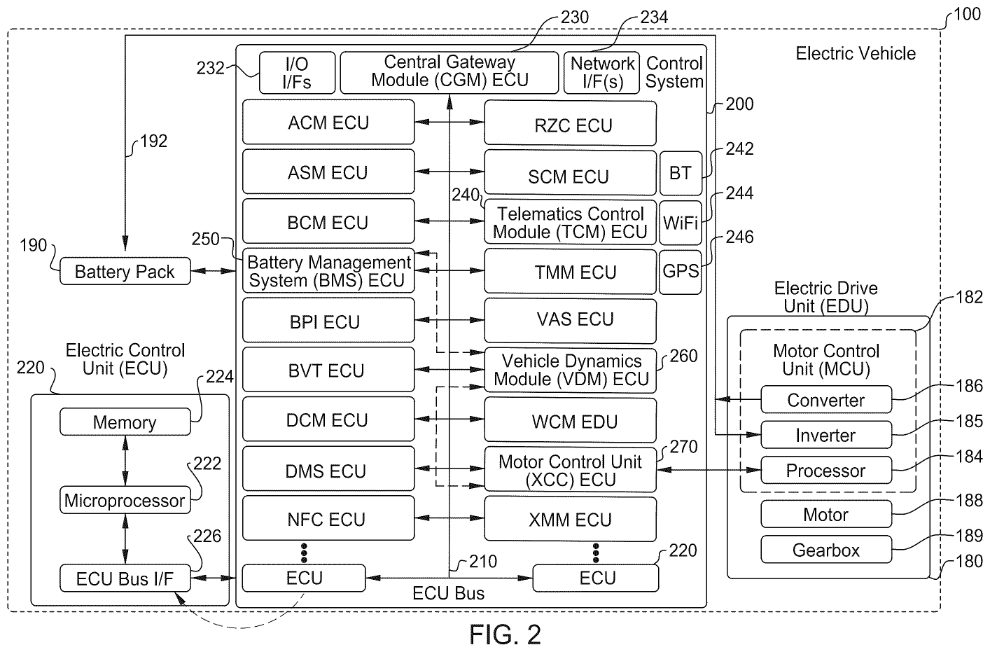

FIG. 2 presents a block diagram of example components of electric vehicle 100, in accordance with embodiments of the present disclosure.

Generally, electric vehicle 100 includes control system 200 that is configured to perform the functions necessary to operate electric vehicle 100. In certain embodiments, control system 200 includes a number of ECUs 220 coupled to ECU bus 210 (also known as a controller area network or CAN). Each ECU 220 performs a particular set of functions, and includes, inter alia, microprocessor 222 coupled to memory 224 and ECU bus interface (I/F) 226.

In certain embodiments, control system 200 may include a number of system-on-chips. Each system-on-chip may include a number of multi-core processors coupled to a high-speed interconnect and on-chip memory that provide more robust functionality and performance than a single ECU 220. Accordingly, each system-on-chip may combine the functionality provided by several ECUs 220.

Control system 200 may be coupled to sensors (such as cameras, radar sensors, ultrasonic sensors, etc.), actuators (such as electric, hydraulic, pneumatic, etc.), input/output (I/O) devices, as well as other components within the propulsion system, the electrical power storage and distribution system, the suspension system, the steering system, the auxiliary and accessory systems, etc., such as EDU 180, battery pack 190, etc.

Control system 200 may include central gateway module (CGM) ECU 230 which provides a central communications hub for electric vehicle 100. CGM ECU 230 includes (or is coupled to) I/O interfaces (I/Fs) 232 to receive data from, and send commands to, various vehicle components, such as sensors, actuators, input devices, output devices, etc. CGM ECU 230 also includes (or is coupled to) network interfaces (I/Fs) 234 to provide network connectivity through ECU bus ports, local interconnect network (LIN) ports, Ethernet ports, etc.

CGM ECU 230 may route messages (including commands, data, etc.) over ECU bus 210 from one ECU 220 to another ECU 220, or from one ECU 220 to multiple ECUs 220 (such as broadcast messages, etc.). In one example, CGM ECU 230 may receive a message from a source ECU 220, process the message to determine, inter alia, the destination ECU 220, and then transmit the message to the destination ECU 220. In another example, CGM ECU 230 may simply arbitrate ECU bus 210 to allow the source ECU 220 to send a message directly to the destination ECU 220. For example, battery management system (BMS) ECU 250 may send a message to vehicle dynamic module (VDM) ECU 260 that includes a maximum battery charge DC current for battery pack 190, motor control unit (XCC) ECU 270 may send a message to VDM ECU 260 that includes the available regeneration torque, etc.

CGM ECU 230 may receive data from a sensor, an I/O device, a vehicle component, etc., and then send a message containing the data to the appropriate ECU 220 over ECU bus 210. Similarly, CGM ECU 230 may receive a message containing a command or data from a source ECU 220, and then send the command or the data to the appropriate actuator, I/O device, vehicle component, etc. Additionally, CGM ECU 230 may manage the vehicle mode (such as road driving mode, off-roading mode, tow mode, camping mode, parked mode, etc.), and may control certain vehicle components related to transitioning from one vehicle mode to another vehicle mode.

Control system 200 may include telematics control module (TCM) ECU 240 which provides a wireless communications hub for electric vehicle 100. TCM ECU 240 may include (or may be coupled to) Bluetooth (or Bluetooth Low Energy) transceiver 242, WiFi transceiver 244, GPS receiver 246, etc.

Control system 200 may include battery management system (BMS) ECU 250 to manage the charging of battery pack 190, as well as to perform other related tasks.

In certain embodiments, one or more ECUs 220 may include the necessary interfaces to be coupled directly to particular sensors, actuators, I/O devices, and other vehicle system components. For example, BMS ECU 250 may be coupled directly to battery pack 190, motor control unit (XCC) ECU 270 may be coupled directly to one or more EDUs 180, etc. Additionally, components may also be coupled directly to one another. For example, battery pack 190 may be directly coupled to one or more EDUs 180, etc.

In certain embodiments, EDU 180 may include, inter alia, MCU 182, motor 188, and gearbox 189 (coupled to wheel(s) 170), while MCU 182 may include, inter alia, processor 184, inverter 185, and converter 186. Accordingly, XCC ECU 270 may be coupled directly to processor 184 via a communication signal cable, BMS ECU 250 may be coupled directly to battery pack 190 via a communication signal cable, and battery pack 190 may be coupled directly to inverter 185 and converter 186 via one or more HV cables 192. In certain embodiments, the functionality provided by inverter 185 and converter 186 may be combined into a single component, such as inverter 185.

In certain embodiments, control system 200 may also include, inter alia, autonomy control module (ACM) ECU, autonomous safety module (ASM) ECU, body control module (BCM) ECU, battery power isolation (BPI) ECU, balancing voltage temperature (BVT) ECU, door control module (DCM) ECU, driver monitoring system (DMS) ECU, near-field communication (NFC) ECU, rear zone control (RZC) ECU, seat control module (SCM) ECU, thermal management module (TMM) ECU, vehicle access system (VAS) ECU, winch control module (WCM) ECU, experience management module (XMM) ECU, etc.

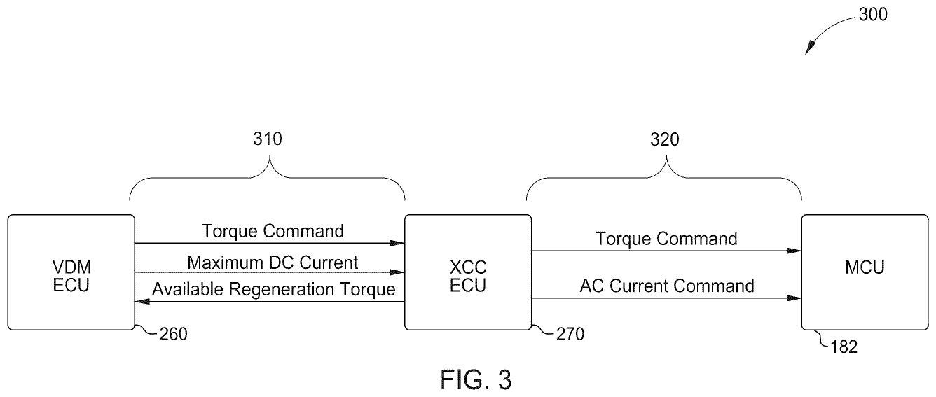

FIG. 3 presents block diagram 300 depicting data interfaces between several vehicle components, in accordance with embodiments of the present disclosure.

In certain embodiments, data 310 are exchanged between VDM ECU 260 and XCC ECU 270 over ECU bus 210, and data 320 are exchanged between XCC ECU 270 and MCU 182 (of EDU 180) over a communication signal cable. While FIG. 3 depicts a single MCU 182, data 320 may be exchanged between XCC ECU 270 and multiple MCUs 182, such as two MCUs 182 (i.e., two EDUs 180 each with a single MCU 182), four MCUs 182 (i.e., two EDUs 180 each with two MCUs 182), etc. Generally, a single XCC ECU 270 may control all of the EDUs 180, a different XCC ECU 270 may control each EDU 180, or a different XCC ECU 270 may control each MCU 182.

Data 310 may include, inter alia, a torque command, a maximum DC current, and an available regeneration torque.

During regenerative braking, BMS ECU 250 may determine the maximum DC current that may be accepted by battery pack 190 based on various factors, such as SoC, battery pack temperature, etc., and periodically send the maximum DC current to VDM EDU 260 over ECU bus 210.

VDM ECU 260 may determine the torque command based on, inter alia, a desired regeneration torque and, in certain conditions, the available regeneration torque. Generally, the desired regeneration torque represents a portion of the total braking torque that is to be provided by motor regeneration. When friction braking is not applied (such as during one-pedal driving mode, during operation of an electro-mechanical axle disconnect, etc.), the desired regeneration torque represents the total braking torque. VDM ECU 260 may periodically send the torque command and the maximum DC current to XCC ECU 270.

XCC ECU 270 may determine the available regeneration torque, and periodically send the available regeneration torque to VDM ECU 260.

Data 320 may include, inter alia, the torque command, and an AC current command.

During regenerative braking, XCC ECU 270 may also determine the AC current command based on, inter alia, the torque command, the maximum DC current, and a drive unit loss, and periodically send the torque command and the AC current command to MCU 182.

During road driving, off-road driving, and towing, VDM ECU 260 receives data from one or more ECUs 220, such as accelerator pedal data, etc. VDM ECU 260 may determine that a positive torque value (Newton-meters or N·m) is required based on the data. VDM ECU 260 then generates the torque command (N·m), and sends the torque command to XCC ECU 270. When VDM ECU 260 receives other data from one or more ECUs 220, such as brake pedal data, accelerator pedal data during one-pedal driving, etc., VDM ECU 260 may determine that a negative torque value is required based on the other data. VDM ECU 260 then generates the torque command, and sends the torque command and the DC maximum current (ampere or A) to XCC ECU 270. Other data may also be received from VDM ECU 260, such as the DC voltage value (volts or V), etc., or from MCU 182, such as the motor speed value (milliradians/second or mrad/s), etc.

When XCC ECU 270 receives a torque command with a negative torque value, XCC ECU 270 enters regeneration mode. In response, MCU 182 disconnects inverter 185 from battery pack 190, connects converter 186 to battery pack 190, and switches motor 188 from AC motor mode to AC generator mode. Motor 188 then begins to generate AC current, which is converted to DC current by converter 186 and provided to battery pack 190 via HV cable 192.

Generally, EDU 180 experiences losses which limit the amount of AC current that may be generated and converted to DC current. In certain embodiments, these losses may be expressed as a drive unit loss (DUL) that includes an inverter loss (or converter loss), a motor loss, a spin loss, and a resistance loss (or copper). The inverter loss (or converter loss) may be expressed as a function of the AC motor current (I_{S}), the DC voltage (V_{DC}), and the switching behavior. The motor loss may be expressed as a function of the AC motor current (I_{S}), the DC voltage (V_{DC}), the speed (mrad/s), the temperature, and resistor values. The spin loss may be expressed as a function of speed (mrad/s). The resistance loss may be expressed as a function of the AC motor current (I_{S}) and resistor values.

During regeneration mode operation, the amount of DC current (I_{DC}) that is generated by EDU 180 and provided to battery pack 190 is generally related to the torque command. When the torque command increases, the generated DC current increases; conversely, when the torque command decreases, the generated DC current decreases. However, the torque command may reach an upper limit (or torque threshold T_{T}) during regeneration mode operation because the generated DC current should not be increased above the maximum DC current (I_{DCmax}). In other words, the torque threshold (T_{T}) generally corresponds to a torque that generates the maximum amount of DC current that is acceptable by battery pack 190.

In one embodiment, the torque threshold may be expressed as:

$${T}_{T} = ( {V}_{D C} \cdot {I}_{D Cmax} + D UL ) / ω \qquad Eq . 1$$

Where ω is the speed in mrad/s. When VDM ECU 260 sends a torque command (T_{cmd}) to XCC ECU 270 that is above the torque threshold (T_{T}), VDM ECU 260 is requesting an excessive amount of torque that would generate an excessive amount of DC current that cannot be absorbed by battery pack 190.

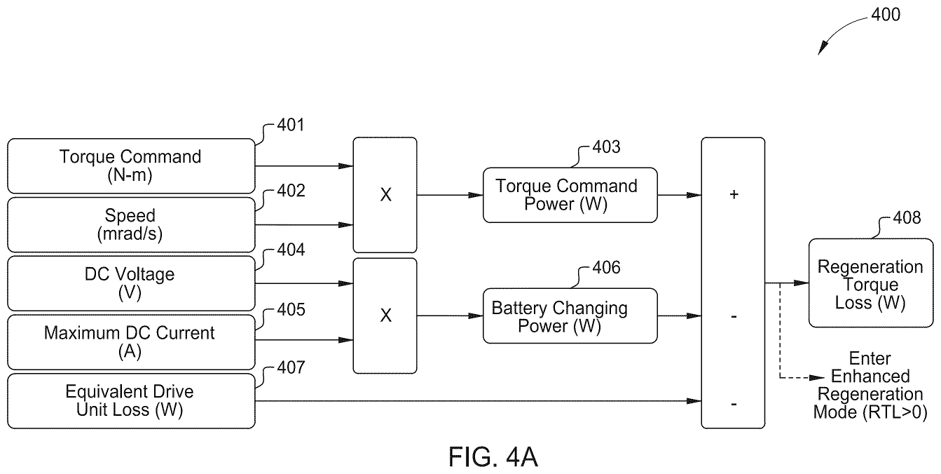

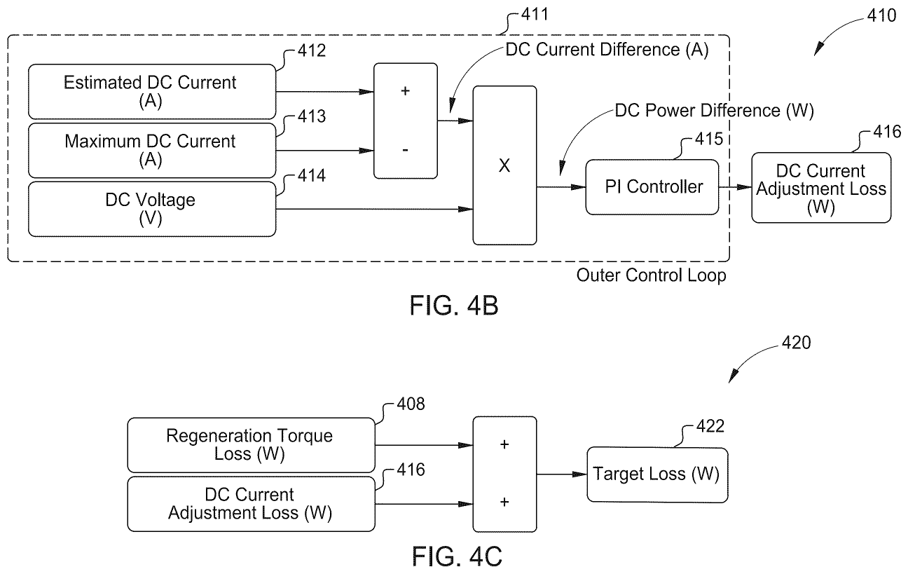

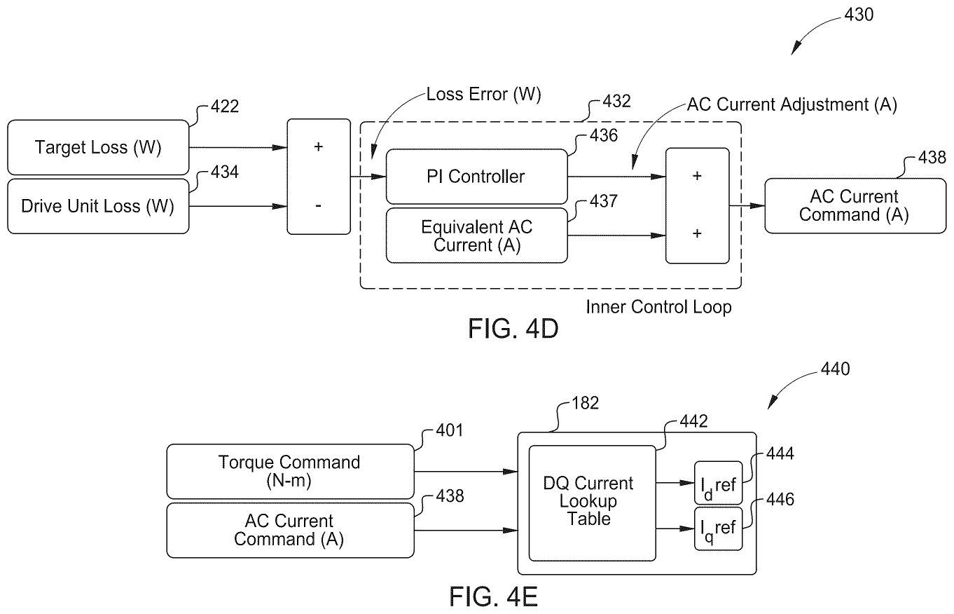

FIGS. 4A to 4E present example block diagrams for motor regeneration, in accordance with embodiments of the present disclosure.

Advantageously, embodiments of the present disclosure provide an enhanced regeneration mode that increases the drive unit loss (DUL) to compensate for a torque command (T_{cmd}) that is above the torque threshold (T_{T}) without generating a DC current (I_{DC}) in excess of the maximum DC current (I_{DCmax}). In other words, the increase in drive unit loss (ΔDUL) prevents the generation of additional current (ΔI_{DC}) that would otherwise have been generated by the additional torque (ΔT_{cmd}) above the torque threshold (T_{T}) and have caused excessive DC current to be sent to battery pack 190. Advantageously, enhanced regeneration mode operates at maximum efficiency because the generated DC current (I_{DC}) is the maximum amount of DC current that is acceptable by battery pack 190.

XCC ECU 270 may enter enhanced regeneration mode from regeneration mode when VDM ECU 260 sends a torque command (T_{cmd}) that is above the torque threshold (T_{T}).

In one embodiment, the enhanced regeneration mode entrance or activation condition may be expressed as:

$${T}_{c m d} > {T}_{T} \qquad Eq . 2$$

A hysteresis dead band may be added to the torque threshold (T_{T}) to prevent undesirable mode changes or oscillations. Similarly, the enhanced regeneration mode exit or deactivation condition may be expressed as:

$${T}_{c m d} < {T}_{T} \qquad Eq . 3$$

FIG. 4A presents block diagram 400 for motor regeneration, in accordance with embodiments of the present disclosure.

Block diagram 400 presents another way to view the enhanced regeneration mode entrance or activation condition. XCC ECU 270 multiplies torque command 401 and motor speed 402 to generate torque command power 403 (Watts or W), and multiplies DC voltage 404 and maximum DC current 405 to generate maximum possible battery charging power 406 (W). Equivalent drive unit loss 407 (W) represents the drive unit loss at the efficient operating point (i.e., at the commanded torque and motor speed with no additional drive unit losses). XCC ECU 270 subtracts battery charging power 406 and equivalent drive unit loss 407 from torque command power 403 to generate regeneration torque loss 408 (W). When regeneration torque loss 408 is greater than 0, to XCC ECU 270 enters or activates enhanced regeneration mode.

In certain embodiments, the transition from regeneration mode to enhanced regeneration mode may be delayed to allow higher priority process to conclude, such as zero-crossing, anti-clunk, etc. Additionally, the drive unit loss may be limited to a maximum value (DULₘₐₓ) when the temperature of EDU 180 reaches a first temperature threshold (Temp_{T1}), and enhanced regeneration mode may be exited or deactivated when the temperature exceeds a second temperature threshold (Temp_{T2}) that is greater than the first temperature threshold (i.e., Temp_{T2}>Temp_{T1}).

FIG. 4B presents block diagram 410 for motor regeneration, in accordance with embodiments of the present disclosure.

The DC current that is generated and provided to battery pack 190 may be controlled by outer control loop 411. XCC ECU 270 estimates the DC current (I_{DC}) that is provided to battery pack 190 based on the AC current (I_{S}) and the duty cycles. XCC ECU 270 then subtracts maximum DC current 413 from estimated DC current 412, and multiplies the DC current difference (or error) by DC voltage 414 to generate a DC power difference (W), which is provided to proportional integral (PI) controller 415. The goal of outer control loop 411 is to control the generated DC current to be equal to the maximum amount of DC current that is acceptable to battery pack 190.

When the estimated I_{D}C is greater than maximum DC current 413 (i.e., when the DC current difference is positive), PI controller 415 increases the drive unit losses to reduce the generated DC current. Conversely, when the estimated I_{D}C is less than maximum DC current 413 (i.e., when the DC current difference is negative), PI controller 415 reduces the drive unit losses to operate EDU 180 more efficiently. PI controller 415 outputs DC current adjustment loss 416. In certain embodiments, the bandwidth of PI controller 415 may be 4 Hz.

FIG. 4C presents block diagram 420 for motor regeneration, in accordance with embodiments of the present disclosure.

XCC ECU 270 adds regeneration torque loss 408 (in Watts) and DC current adjustment loss 416 (in Watts) to generate target loss 422 (in Watts).

FIG. 4D presents block diagram 430 for motor regeneration, in accordance with embodiments of the present disclosure.

As discussed above, to compensate for a torque command (T_{cmd}) that is above the torque threshold (T_{T}) without generating a DC current (I_{DC}) in excess of the maximum DC current (I_{DCmax}), the drive unit loss (DUL) may be increased. The root-mean-square (rms) value of the AC current may be used to increase (and decrease) the drive unit loss at a certain speed and DC voltage.

The AC current command 438 that is generated and provided to MCU 182 may be controlled by inner control loop 432. XCC ECU 270 determines drive unit loss 434 (as discussed above). XCC ECU 270 also determines equivalent AC current 437 (A) that represents the AC current (I_{MPTA}) at the efficient operating point (i.e., at the maximum torque per ampere or MTPA). XCC ECU 270 subtracts drive unit loss 434 from target loss 422 to generate a loss error (W), which is provided to PI controller 436. PI controller 436 outputs an AC current adjustment (A). XCC ECU 270 then adds the AC current adjustment and equivalent AC current 437 to generate AC current command 438. Generally, the bandwidth of PI controller 436 is faster than the bandwidth of PI controller 415. In certain embodiments, the bandwidth of PI controller 436 may be 20 Hz, and the bandwidth of PI controller 415 may be 4 Hz.

The AC current adjustment may be corrected for saturation. For example, the AC current adjustment may have a maximum value of the difference between the maximum AC current (I_{S,max}) and I_{MPTA} (i.e., I_{S,max}−I_{MPTA}), and a minimum value of 0. AC current command 438 may also be corrected for saturation. For example, AC current command 438 may have a maximum value of the maximum AC current (I_{S,max}), and a minimum value of I_{MPTA}. When AC current command 438 is set to I_{S,max}, the drive unit losses are set to the maximum losses allowed, and when AC current command 438 is set to I_{MPTA}, the drive unit losses are set to the minimum losses allowed.

FIG. 4E presents block diagram 440 for motor regeneration, in accordance with embodiments of the present disclosure.

Torque command 401 and AC current command 438 are provided to MCU 182, which queries DQ Current Lookup Table 442 to determine the DQ current references I_{d} ref 444 and I_{q} ref 446, which are provided to the motor current vector controller for motor 188.

In certain embodiments, an electric drive system may include, inter alia, XCC ECU 270 and one or more EDUs 180.

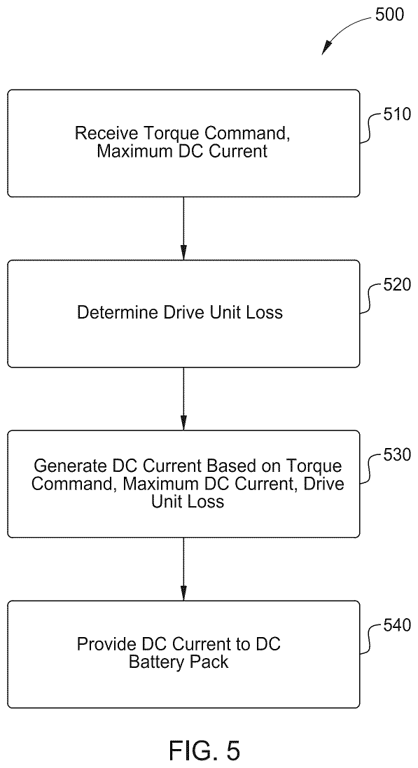

FIG. 5 depicts flow chart 500 representing functionality associated with synchronizing charge status lights, in accordance with embodiments of the present disclosure.

At 510, a torque command and a DC current maximum value are received from an ECU. As discussed above, the torque command and the maximum DC current may be sent from VDM ECU 260 to XCC ECU 270.

At 520, a drive unit loss is determined. As discussed above, XCC ECU 270 may determine the drive unit loss. In certain embodiments, the drive unit loss may include at least one of an inverter loss (or converter loss), a motor loss, a spin loss, and a resistance loss (or copper).

At 530, a DC current is generated based, at least in part, on the torque command, the maximum DC current, and the drive unit loss. As discussed above with respect to FIGS. 4A to 4D, XCC ECU 270 determines an AC current command based on, inter alia, the torque command and the maximum DC current, provides the torque command and the AC current command to MCU 182, which controls the generation of AC current by motor 188. The AC current generated by motor 188 is converted to DC current by converter 186.

At 540, the DC current is provided to a DC battery pack. As discussed above, EDU 180 is coupled to battery pack 190 via HV cable 192. More particularly, converter 186 provides the generated DC current to battery pack 190.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method for motor regeneration, comprising:
receiving, from an electronic control unit (ECU), a torque command and a maximum direct current (DC) current;
determining a drive unit loss;
generating a DC current based, at least in part, on the torque command, the maximum DC current, and the drive unit loss; and
providing the DC current to a DC battery pack.

2. The method of claim 1, further comprising:
determining an available regeneration torque; and
sending, to the ECU, the available regeneration torque.

3. The method of claim 1, wherein generating a DC current includes:
determining a target loss;
determining a loss error based on the target loss and the drive unit loss;
generating an alternating current (AC) current based, at least in part, on the loss error;
converting the AC current into the DC current.

4. The method of claim 3, wherein determining the target loss includes:
determining a regeneration torque loss based, at least in part, on the torque command and the maximum DC current;
determining a DC current adjustment loss; and
combining the regeneration torque loss and the DC current adjustment loss to generate the target loss.

5. The method of claim 4, wherein determining the DC current adjustment loss includes:
when an estimated DC current is greater than the maximum DC current, increasing the drive unit loss; and
when the estimated DC current is less than the maximum DC current, decreasing the drive unit loss.

6. The method of claim 5, wherein determining the loss error includes subtracting the drive unit loss from the target loss to generate the loss error.

7. The method of claim 6, wherein generating of the AC current includes:
determining an AC current command based, at least in part, on the loss error; and
providing the AC current command and the torque command to a motor control unit.

8. The method of claim 7, wherein determining the AC current command includes:
determining an AC current adjustment;
determining an equivalent AC current; and
adding the AC current adjustment and the equivalent AC current to generate the AC current command.

9. The method of claim 8, wherein:
increasing the AC current command increases the drive unit loss; and
decreasing the AC current command decreases the drive unit loss.

10. The method of claim 1, wherein the drive unit loss includes at least one of an inverter loss, a motor loss, a spin loss, and a resistance loss.

11. An electric drive system for an electric vehicle, comprising:
an electronic control unit (ECU), coupled to an electric drive unit (EDU), the ECU configured to:
receive, from a different ECU, a torque command and a maximum DC current;
determine a drive unit loss; and
control generation of a DC current based, at least in part, on the torque command, the maximum DC current, and the drive unit loss.

12. The electric drive system of claim 11, wherein the EDU includes:
an AC motor having a motor mode and a generator mode; and
a motor control unit (MCU) including:
an inverter configured to convert DC current from a DC battery pack into AC current for the AC motor, and
a converter configured to convert AC current generated by the AC motor into DC current for recharging the DC battery pack.

13. The electric drive system of claim 12, wherein:
the ECU is further configured to:
determine an available regeneration torque,
send, to the different ECU, the available regeneration torque determine a target loss,
determine a loss error based on the target loss and the drive unit loss; and
the AC motor is configured to generate the AC current based, at least in part, on the loss error.

14. The electric drive system of claim 13, wherein determine the target loss includes:
determine a regeneration torque loss based, at least in part, on the torque command and the maximum DC current;
determine a DC current adjustment loss; and
combine the regeneration torque loss and the DC current adjustment loss to generate the target loss.

15. The electric drive system of claim 14, wherein determine the DC current adjustment loss includes:
when an estimated DC current is greater than the maximum DC current, increase the drive unit loss; and
when the estimated DC current is less than the maximum DC current, decrease the drive unit loss.

16. The electric drive system of claim 15, wherein determine the loss error includes subtracting the drive unit loss from the target loss to generate the loss error.

17. The electric drive system of claim 16, wherein the ECU is further configured to:
determine an AC current command based, at least in part, on the loss error; and
provide the AC current command and the torque command to the MCU.

18. The electric drive system of claim 17, wherein determine the AC current command includes:
determine an AC current adjustment;
determine an equivalent AC current; and
add the AC current adjustment and the equivalent AC current to generate the AC current command.

19. The electric drive system of claim 18, wherein:
increasing the AC current command increases the drive unit loss; and
decreasing the AC current command decreases the drive unit loss.

20. The electric drive system of claim 12, wherein the drive unit loss includes at least one of an inverter loss, a motor loss, a spin loss, and a resistance loss.
